(19) United States
(12) Patent Application Publication
(10) Pub. No.: US 2014/0244258 A1
(43) Pub. Date: Aug. 28, 2014

(54) SPEECH RECOGNITION METHOD OF SENTENCE HAVING MULTIPLE INSTRUCTIONS

(71) Applicant: Mediazen Co., Ltd., Seongnam-Si (KR)

(72) Inventors: Minkyu SONG, Seongnam-Si (KR); Hyejin KIM, Seongnam-Si (KR); Sangyoon KIM, Seongnam-Si (KR)

(73) Assignee: Mediazen Co., Ltd., Seongnam-Si (KR)

(21) Appl. No.: 14/058,088

(22) Filed: Oct. 18, 2013

(30) Foreign Application Priority Data
Feb. 25, 2013 (KR) 10-2013-0019991

(51) Int. Cl. G10L 17/14

(52) U.S. Cl. CPC G10L 17/14
USPC 704/249

(57) ABSTRACT

A voice recognition method for a single sentence including a multi-instruction in an interactive voice user interface, method includes steps of detecting a connection ending by analyzing the morphemes of a single sentence on which voice recognition has been performed, separating the single sentence into a plurality of passages based on the connection ending, detecting a multi-connection ending by analyzing the connection ending and extracting instructions by specifically analyzing passages including the multi-connection ending and outputting a multi-instruction included in the single sentence by combining the instructions extracted in the step of extracting instructions. In accordance with the present invention, consumer usability can be significantly increased because a multi-operation intention can be checked in one sentence.

### CROSS REFERENCE

The present application claims the benefit of Korean Patent Application No. 10-2013-0019991 filed in the Korean Intellectual Property Office on Feb. 25, 2013 the entire contents of which are incorporated herein by reference.

### BACKGROUND OF THE INVENTION

1. Technical Field

The present invention relates to a voice recognition method for a single sentence including a multi-instruction and, more particularly, to a voice recognition method for a single sentence including a multi-instruction in an interactive voice user interface.

2. Description of the Related Art

FIG. 1 shows an exemplary construction of a known consecutive voice recognition system and shows the structure of a tree-based recognizer that is widely used.

The construction and operation of the known consecutive voice recognition system are already known in the art, and a detailed description thereof is omitted. A process of performing a voice recognition function on input voice is described below in brief.

In the known consecutive voice recognition system, input voice is converted into characteristic vectors including only extracted information useful for recognition through a characteristic extraction unit 101. A search unit 102 searches the characteristic vectors for a string of words having the highest probability in accordance with a Viterbi algorithm using a sound model database (DB) 104, a phonetic dictionary DB 105, and a language model DB 106 that have been constructed in a learning process. Here, in order to recognize a large vocabulary, target vocabularies to be recognized make up a tree, and the search unit 102 searches such a tree.

Finally, a post-processing unit 103 removes noise symbols from search results, performs syllable-based writing, and outputs the final recognition results (i.e., text).

In such a conventional consecutive voice recognition system, in order to recognize consecutive voice, a large tree is formed using target vocabularies to be recognized and searched for using a Viterbi algorithm. A conventional search method having such a structure has a disadvantage in that it is difficult to be applied to the utilization of supplementary information, such as a word phase formation rule, and a high-level language model because a language model and word insertion black marks are also applied to a postpositional word or a word phase having use of the ending upon a transition from a leaf node of a tree to the root of the tree.

Such a problem is described in detail with reference to FIG. 2.

FIG. 2 is an exemplary diagram of a conventional search tree. In FIG. 2, ‘201’ indicates a root node, ‘202’ indicates a leaf node, ‘203’ indicates a common node, and ‘204’ indicates a transition between words. FIG. 2 shows an example of a search tree when target vocabularies to be recognized are Korean word ‘sa gwa (apple, represented as Korean characters ‘ [symbol] ’, and separated as phonemes [symbol] [s], [symbol] [a], [symbol] [g], [symbol] [o], [symbol] [a])’, ‘sa lam (person, ‘ [symbol] ’, and [symbol] [s], [symbol] [a], [symbol] [l], [symbol] [a], [symbol] [m])’, ‘i geot (this, ‘ [symbol] ’, and [symbol] [i], [symbol] [g], [symbol] [eo], [symbol] [t])’, ‘i go (and, ‘ [symbol] ’, and [symbol] [i], [symbol] [g], [symbol] [o])’, and ‘ip ni da (is, ‘ [symbol] ’, and [symbol] [i], [symbol] [p], [symbol] [n], [symbol] [i], [symbol] [d], [symbol] [a])’.

Referring to FIG. 2, all the target vocabularies to be recognized have a form in which they are connected to the one virtual root node 201.

Accordingly, when voice input is received, probability values in all the nodes of the tree are calculated every frame, and only a transition having the highest probability that belong to transitions inputted to the respective nodes remains. Here, since words are changed in the transition from the leaf node 202 to the root node 201, the language model DB 106 is applied in order to restrict a connection between words.

The language model DB 106 stores probability information regarding that which word will appear after a current word. For example, since a probability that a word ‘sagwa (apple, [symbol] )’ will appear after ‘igeot (this, [symbol] )’ is higher than a probability that a word ‘salam (person, [symbol] )’ will appear after ‘igeot (this, [symbol] )’, such information is calculated in the form of a probability value in advance and then used by the search unit 102.

In general, in consecutive voice recognition, voice is frequently recognized as words having a small number of phonemes. In order to prevent such a problem, the number of recognized words in a recognized sentence is controlled by adding word insertion black marks having a specific value when a transition occurs between word.

As shown in FIG. 2, in the conventional voice recognition method using a tree, all words are processed using the same method. Accordingly, when a word phase made up of a ‘noun+postpositional word’ or ‘between-predicates+ending’ as in Korean is inputted, there is a problem in that input voice is recognized as one word rather than the ‘noun+postpositional word’ or ‘between-predicates+ending’ because word insertion black marks are added upon transition between all words.

In particular, a voice recognition apparatus for a vehicle is driven by a relatively simple operation and is problematic in that the time taken to recognize voice is long as compared with physical input for an instruction.

In general, in order to use a voice recognition apparatus for a vehicle, a user performs a first step of clicking on the operation button of the voice recognition apparatus, a second step of listening to a guide speech, such as “Please speak an instruction”, a third step of speaking specific words, a fourth step of listening to a confirmation speech for words recognized by the voice recognition apparatus, and a fifth step of speaking whether or not to perform the words recognized by the voice recognition apparatus for about 10 seconds.

In contrast, if a user inputs an instruction through a physical method, the instruction can be completed by one step of touching a button corresponding to the instruction.

A Point Of Interest (POI) search using voice recognition or a search, such as an address search, is faster than a search using a physical method. However, an excessive time taken for a basic operation and the occurrence of erroneous recognition in the POI search or the address search cause the deterioration of reliability in voice recognition technology.

Accordingly, there is an urgent need to develop technology for solving the aforementioned problems by supporting multiple operations in one spoken sentence.

### SUMMARY OF THE INVENTION

Accordingly, the present invention has been made keeping in mind the above problems occurring in the prior art, and an object of the present invention is to provide a voice recognition method for a single sentence including a multi-instruction, which is capable of easily recognizing a multi-instruction included in one sentence although a user speaks the one sentence and outputting a corresponding operation.

In accordance with an embodiment of the present invention, there is provided a voice recognition method for a single sentence including a multi-instruction, including includes steps of detecting a connection ending by analyzing the morphemes of a single sentence on which voice recognition has been performed, separating the single sentence into a plurality of passages based on the connection ending, detecting a multi-connection ending by analyzing the connection ending and extracting instructions by specifically analyzing passages including the multi-connection ending and outputting a multi-instruction included in the single sentence by combining the instructions extracted in the step of extracting instructions.

In accordance with the present invention, user usability is greatly improved because multiple operation intentions can be checked in one sentence.

Furthermore, in accordance with the present invention, an algorithm can be simply implemented because a method of referring to a language information DB 60 in which a previously constructed language information dictionary is stored is used.

Furthermore, in accordance with the present invention, the number of multiple operations is not limited because grammatical connection information is checked. That is, processing for N multiple operations can be performed through a single sentence spoken by a speaker.

Furthermore, unlike in existing language processing technology having a low success ratio, the present invention can significantly improve a success ratio because only processing for two large categories “instruction” and “search” is performed.

### BRIEF DESCRIPTION OF THE DRAWINGS

FIG. 1 is a block diagram showing the construction of a known consecutive voice recognition apparatus.

FIG. 2 is a schematic diagram illustrating a conventional search tree.

FIG. 3 is a flowchart illustrating a voice recognition method in accordance with an embodiment of the present invention.

FIG. 4 shows the construction of a voice recognition apparatus in accordance with an embodiment of the present invention.

FIGS. 5 to 8 are detailed flowcharts illustrating the voice recognition method in accordance with the present invention.

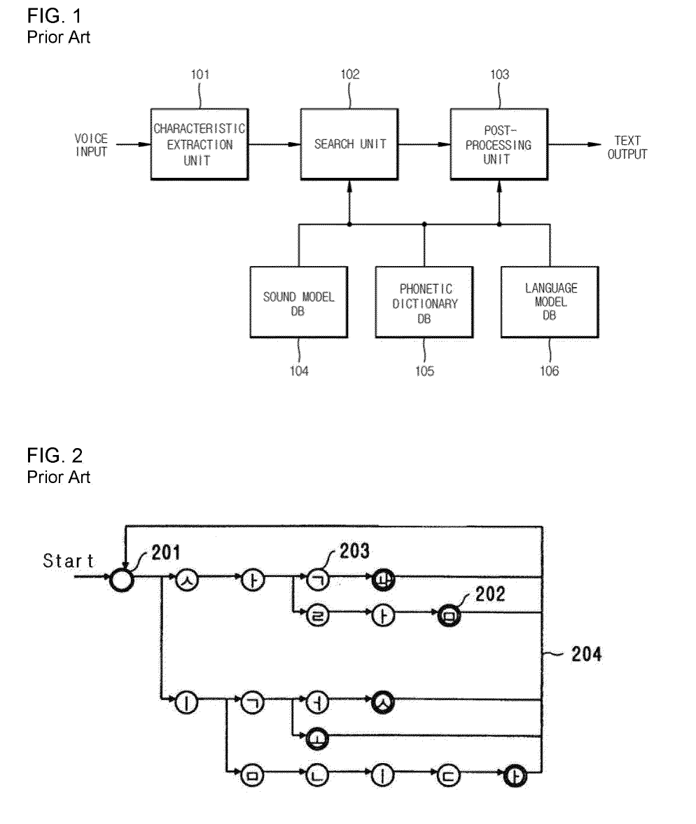

### DETAILED DESCRIPTION OF THE INVENTION

A voice recognition method for a single sentence including a multi-instruction (hereinafter abbreviated as a ‘voice recognition method’) in accordance with an exemplary embodiment of the present invention is described in detail with reference to the accompanying drawings.

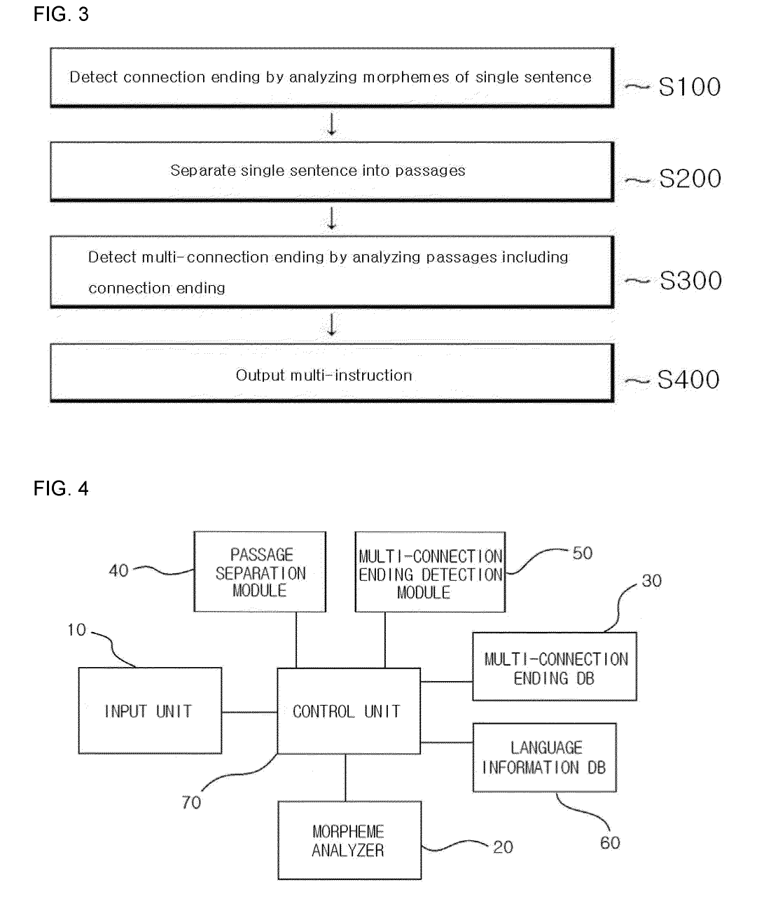

FIG. 3 is a flowchart illustrating a voice recognition method in accordance with an embodiment of the present invention.

The voice recognition method in accordance with the present invention is a voice recognition method of processing multiple operations on a single sentence by analyzing a single sentence inputted through an interactive voice user interface and extracting a plurality of instructions from the single sentence.

Referring to FIG. 3, the voice recognition method in accordance with the present invention includes a first step S100 of detecting a connection ending by analyzing the morphemes of a single sentence on which voice recognition has been performed, a second step S200 of separating the single sentence into a plurality of passages on the basis of the connection ending, a third step S300 of detecting a multi-connection ending by analyzing the connection ending and extracting multiple instructions by specifically analyzing passages including the multi-connection ending, and a fourth step S400 of outputting a multi-instruction included in the single sentence by combining the multiple instructions extracted at step S300.

The voice recognition method can be implemented using a voice recognition apparatus as shown in FIG. 4. The voice recognition apparatus includes an input unit 10 configured to collect pieces of voice information about a single sentence spoken by a user and extract text data from the pieces of voice information, a morpheme analyzer 20 configured to analyze morphemes included in the text data of the single sentence, a multi-connection ending DB 30 configured to detect a connection ending in the morphemes analyzed from the text data, a passage separation module 40 configured to separate the text data into one or more passages on the basis of the detected connection ending, a multi-connection ending detection module 50 configured to detect a multi-connection ending in the connection ending included in the passages, a language information DB 60 configured to previously store a language information dictionary, and a control unit 70 connected to the elements and configured to control the elements.

The voice recognition apparatus may further include a manipulation unit (not shown) for receiving an operation signal from a user, an output module (not shown) for providing an interactive voice user interface in response to the operation signal received from the manipulation unit, a memory unit (not shown) for storing text data of a single sentence collected through the input unit 10, and a part-of-speech classification module (not shown) for classifying each of passages including a multi-connection ending according to a part of speech and assigning a meaning value to each of the parts of speech.

Each of the steps is described in detail below with reference to the accompanying drawings.

In the voice recognition method in accordance with the present invention, first, the first step of detecting a connection ending by analyzing the morphemes of a single sentence on which voice recognition has been performed is performed at step S100.

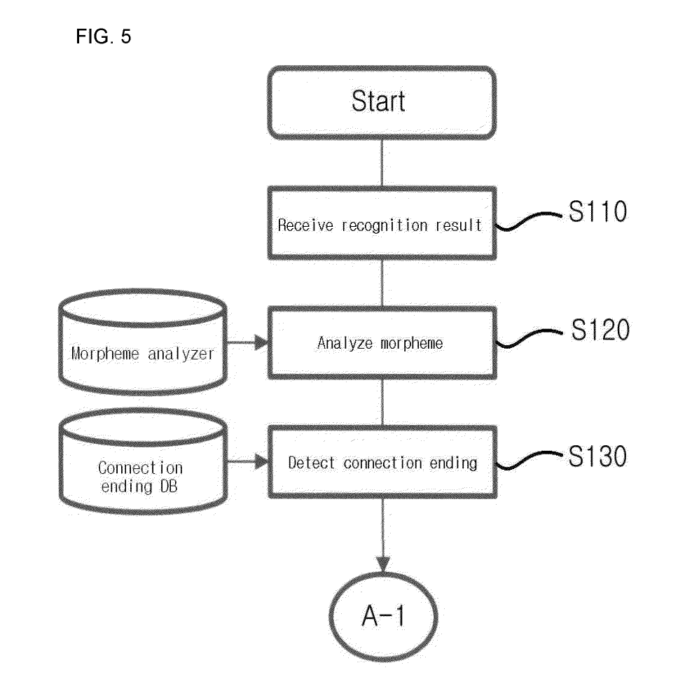

FIG. 5 is a flowchart illustrating one section of the voice recognition method in accordance with the present invention.

Referring to FIG. 5, the first step S100 includes a voice recognition process S110 of recognizing a user's voice for a single sentence, morpheme analysis process S120 of analyzing the morphemes of the single sentence through the morpheme analyzer 20, and a connection ending detection process S130 of detecting a connection ending from the morphemes through the multi-connection ending DB 30.

In the voice recognition process S110, when a user gives an instruction to the voice recognition apparatus by touching the manipulation unit, the control unit 70 of the voice recognition apparatus provides the user with an interactive voice user interface through the output module and collects voice information about a single sentence spoken by the user through the input unit 10. To this end, the input unit 10 is equipped with a microphone. Next, the input unit 10 converts the voice information of the single sentence, collected through the microphone, into text data and provides the text data to the control unit 70.

In the morpheme analysis process S120, the control unit 70 analyzes morphemes that make up the text data of the single sentence through the morpheme analyzer 20.

In the connection ending detection process S130, the control unit 70 detects a connection ending in the morphemes analyzed in the morpheme analysis process S120. Here, the connection ending is detected through the multi-connection ending DB 30 in which a connection ending dictionary has been constructed.

The control unit 70 may store the text data of the single sentence received from the input unit 10, that is, voice information about the single sentence spoken by the user, in the memory unit.

Next, in the voice recognition method in accordance with the present invention, the second step of separating the single sentence into a plurality of passages on the basis of the connection ending is performed at step S200.

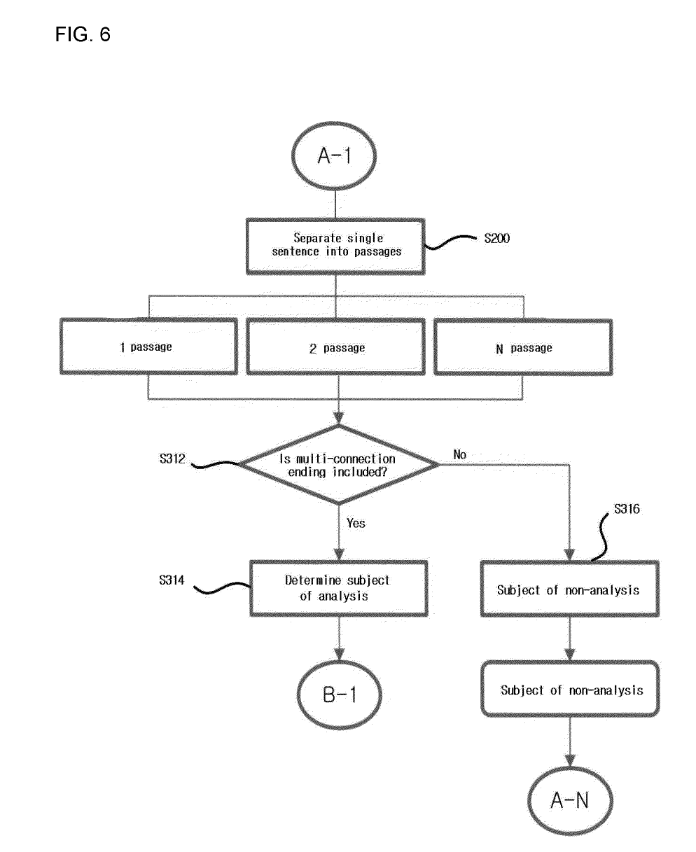

FIG. 6 is a flowchart illustrating another section of the voice recognition method in accordance with the present invention.

Referring to FIGS. 3 and 6, at step S200, the control unit 70 provides the passage separation module 40 with the connection ending detected in the first step S100. Next, the passage separation module 40 separates the text data of the single sentence into a plurality of passages on the basis of the connection ending detected in the first step S100.

Next, in the voice recognition method in accordance with the present invention, the third step of detecting a multi-connection ending by analyzing the connection ending and extracting an instruction by specifically analyzing a passage including the multi-connection ending is performed at step S300.

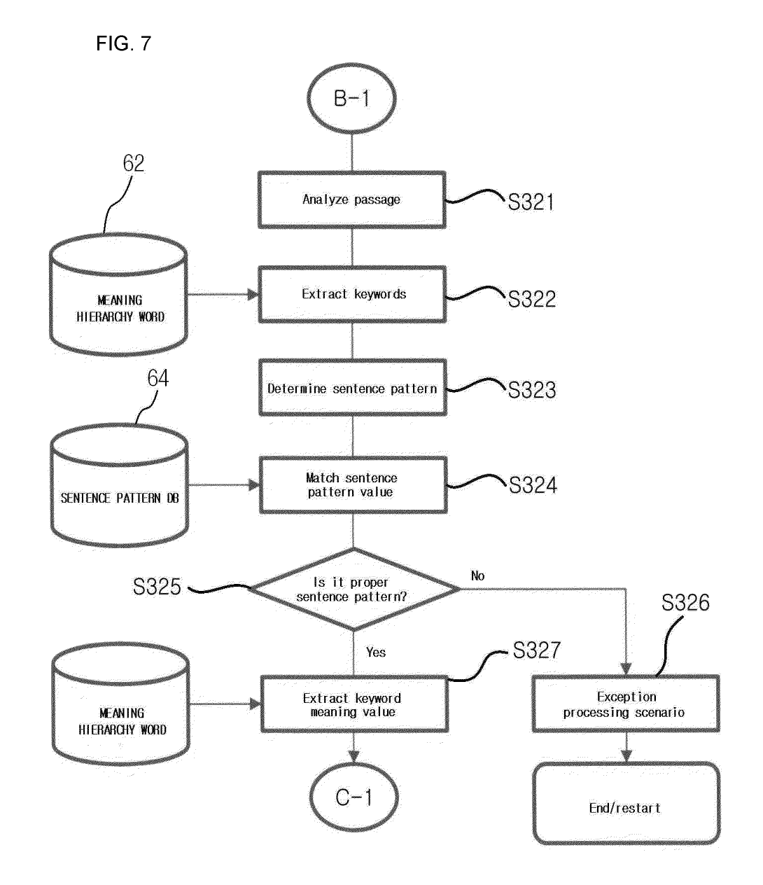

FIG. 7 is a flowchart illustrating yet another section of the voice recognition method in accordance with the present invention.

Referring to FIGS. 6 and 7, the third step S300 includes an analysis target determination process S310 of detecting a multi-connection ending by analyzing a connection ending and classifying the multi-connection into the subject of analysis and the subject of non-analysis depending on whether the multi-connection ending is present or not and an instruction extraction process S320 of extracting instructions by matching passages, corresponding to the subject of analysis, with the language information DB 60 in which the language information dictionary has been previously constructed.

In the analysis target determination process S310, the multi-connection ending detection module 50 detects passages, including a multi-connection ending, in passages including a connection ending under the control of the control unit 70. Here, the multi-connection ending detection module 50 detects the multi-connection ending in the connection ending by comparing the connection endings with each other based on the multi-connection ending DB 30 in which a multi-connection ending dictionary has been previously constructed.

The multi-connection ending means any one of a multi-operation connection ending, a consecutive connection ending, and a time connection ending.

Furthermore, the multi-connection ending refers to the results of a search of a predefined meaning information dictionary. The meaning information dictionary is placed in the multi-connection ending detection module 50. In a connection ending detection process S312, a multi-connection ending registered with the multi-connection ending dictionary is a criterion for analyzing an input sentence.

For example, the multi-operation connection ending may be any one of ‘-go (and, - [symbol] )’, ‘-wa (and, - [symbol] )’, ‘-gwa (and, - [symbol] )’, and ‘-lang (and, - [symbol] )’, the consecutive connection ending may be ‘-umyeonseo (and, - [symbol] )’, and the time connection ending may be any one of ‘-go (and, - [symbol] )’, ‘-umyeo (and, - [symbol] )’, ‘-umyeonseo (and, - [symbol] )’, ‘-ja (as soon as, - [symbol] )’, and ‘-jamaja (as soon as, - [symbol] )’.

More particularly, the multi-operation connection ending ‘-go (and, - [symbol] )’ corresponds to a case where when an instruction, such as “Turn on a radio and (-go) turn off a navigator)”, is given, multiple operations of turning on a radio and turning off a navigator are sequentially performed.

Furthermore, the multi-operation connection ending ‘-lang (and, - [symbol] )’ corresponds to a case where operations of turning on a radio and turning on a navigator are simultaneously performed, for example, as in “Turn on a radio and (-go) a navigator”.

Furthermore, the consecutive connection ending ‘-umyeonseo (and, - [symbol] )’ corresponds to a case where a radio operation and a navigator operation are consecutively performed, for example, as in “Turn on a radio and (-umyeonseo) turn off a navigator)”.

Furthermore, the time connection ending corresponds to a case where an operation matched with an operation point is performed, for example, as in “Turn on a navigator as soon as (-umyeonseo) a radio is turned on)”.

When the multi-connection ending is detected by analyzing the connection ending as described above at step S312, the control unit 70 classifies each of the passages into the subject of analysis and the subject of non-analysis depending on whether a multi-connection ending is present or not at steps S314 and S316. In other words, a passage including a multi-connection ending is defined as the subject of analysis, and a passage not including a multi-connection ending is defined as the subject of non-analysis.

More particularly, the subject of analysis corresponds to a passage on the left of a multi-connection ending, and the subject of analysis is a passage on the left on the basis of the final ending in the last passage of a sentence.

In the instruction extraction process S320, when passages corresponding to the subject of analysis are defined in the analysis target determination process S310, the control unit 70 extracts instructions by matching the passages with the language information DB 60 in which the language information dictionary has been previously constructed.

Here, a meaning hierarchy word DB 62 and a sentence pattern DB 64 may be used as the language information DB 60. Furthermore, the meaning hierarchy word DB 62 refers to a DB in which a dictionary hierarchically constructed according to meaning criteria so that high weight can be assigned to nouns and verbs has been constructed.

More particularly, in the instruction extraction process S320, the control unit 70 analyzes a word phase included in the passage of the subject of analysis at step S321 and then determines a sentence pattern of the passage at step S323 by extracting noun and verbs from the passage of the subject of analysis through the meaning hierarchy word DB 62 at step S322. In such an instruction extraction process S320, interjections, common phrases, commas, and periods included in passages are excluded from the subject of analysis, and the passage of the subject of analysis finally has a structure of <noun>+<verb> at step S324.

The sentence pattern may have a variety of sentence patterns, such as <noun>+<verb>, <noun>+<noun>+<verb>, and <verb>, depending on a result of sentence analysis.

Furthermore, in the instruction extraction process S320, the control unit 70 classifies a previously designated sentence pattern as the subject of output processing at step S325 and classifies sentence patterns other than previously designated sentence patterns as the subject of error processing at step S326 with reference to the sentence pattern DB 64 in which operable essential patterns have been previously defined. Here, error processing can be implemented the spread or end of an exception processing scenario or the generation of a question.

Finally, the control unit 70 assigns a meaning value to the finally determined sentence pattern of the passages <noun>+<verb> with reference to the meaning hierarchy word DB 62 at step S327.

For example, if an instruction ‘radio (radio, - [symbol] )’ has been registered as a target noun to be operated, verbs related to a radio operation, such as “kyeoda (turn on, [symbol] ), dutda (listen to, [symbol] ), and jakdonghada (operate, [symbol] )”, are also registered with the dictionary. A meaning value of the operation of a corresponding verb is subdivided and stored in the meaning hierarchy DB 62. Accordingly, the subject of operation and an operation method when multiple operations are performed can be performed in detail by previously defining detailed meaning values of verbs that corresponding to all operation target nouns.

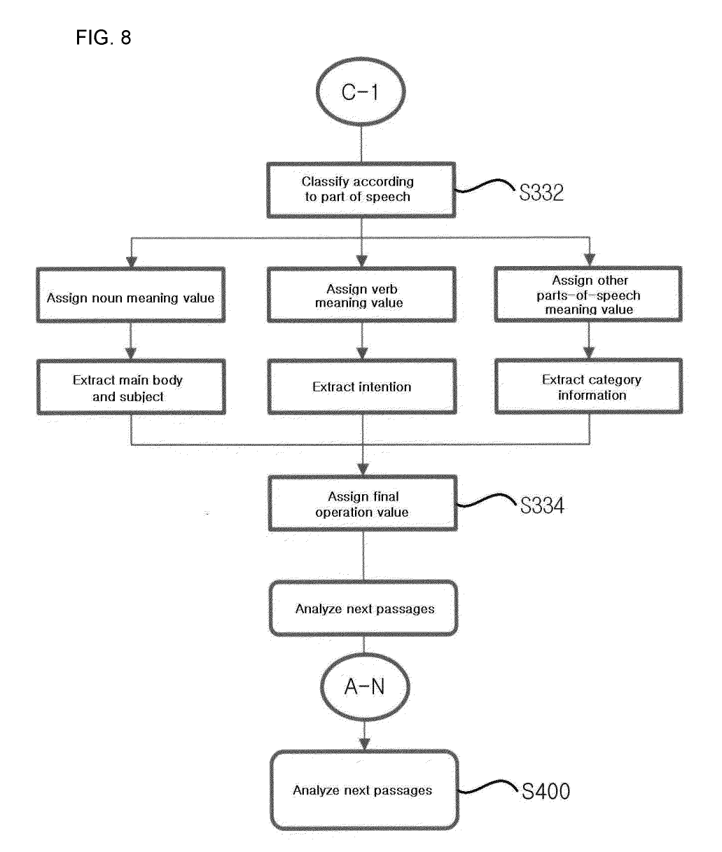

FIG. 8 is a flowchart illustrating further yet another section of the voice recognition method in accordance with the present invention.

Referring to FIGS. 3 and 8, the third step S300 of the voice recognition method in accordance with the present invention may further include a meaning value allocation process S330 of dividing meaning information into extractable units in accordance with part-of-speech classification criteria and analyzing pieces of the divided meaning information after the instruction extraction process S320.

In the meaning value allocation process S330, each of passages whose sentence patterns have been determined by the part-of-speech separation module of the control unit 70 is classified according to each part of speech at step S332.

Furthermore, the control unit 70 assigns a meaning value to each of the parts of speech of the passage. Furthermore, the control unit 70 extracts the main body and the subject through nouns to which the meaning values have been assigned, extracts an intention through verbs to which the meaning values have been assigned, and extracts information about a category through other parts of speech to which the meaning values have been assigned.

Furthermore, the control unit 70 extracts instructions on the basis of the extracted information through the nouns, verbs, and the other parts of speech at step S334.

Finally, in the voice recognition method in accordance with the present invention, the fourth step of outputting multiple instructions included in a single sentence by combining the pieces of instruction extracted in the third step S300 at step S400.

Referring to FIGS. 3 and 8, at step S400, when the analysis of passages corresponding to the subject of analysis, of a plurality of passages that forms a single sentence, is terminated, the control unit 70 determines multiple instructions consisting of a plurality of instructions by combining instructions included in passages.

The output of the multiple instructions can be performed by a process of generating a control signal corresponding to the combined multiple instructions and controlling a corresponding device by sending the control signal to the corresponding device.

The above-described contents are described below, for example.

When a user speaks (for example, a sentence “set Gongneung Station as a destination and (-go) enlarge a map ( [symbol] [symbol] (-go), [symbol] [symbol] )”) at a navigator, the input unit 10 of the voice recognition apparatus extracts text data from the sentence by performing voice recognition on the sentence at step S110.

Next, the control unit 70 analyzes morphemes of the text data through the morpheme analyzer 20 at step S120 and detects an connection ending “-go (and, - [symbol] )”, included in the text data, from the morphemes with reference to the multi-connection ending DB 30 at step S130.

The control unit 70 separates the text data into a first passage “set Gongneung Station as a destination ( [symbol] [symbol] [symbol] )” and a second passage “Enlarge a map ( [symbol] [symbol] )” on the basis of the connection ending “-go (and, - [symbol] )” at step S200.

Furthermore, the control unit 70 classifies the first passage and the second passage as the subject of analysis by detecting the multi-connection ending “-go (and, - [symbol] )” that is included in the first passage “set Gongneung Station as a destination ( [symbol] [symbol] )” through the multi-connection ending DB 30 at step S310.

Next, the control unit 70 extracts a sentence pattern <noun>+<verb> in which ‘Gongneung Station ( [symbol] )’ is a noun and ‘Set a destination ( [symbol] )’ is a verb from “set Gongneung Station as a destination ( [symbol] [symbol] )” through the language information DB 60. Furthermore, the control unit 70 assigns meaning values to ‘Gongneung Station ( [symbol] )’ and ‘Set a destination ( [symbol] [symbol] )’ through the meaning hierarchy word DB 62. Here, the destination of the navigator is extracted by assigning the meaning value to ‘Gongneung Station ( [symbol] )’, and a user's intention (i.e., a driving path guide for the destination) is extracted by assigning the meaning value to ‘Set a destination ( [symbol] )’. Finally, a result value is assigned to the first passage, and thus an instruction is extracted at step S320.

Next, when the assignment of the result value to the first passage is completed, the control unit 70 extracts the instruction of the second passage by analyzing the second passage and outputs the multiple instructions for the sentence at step S400. In other words, since the sentence “set Gongneung Station as a destination and (-go) enlarge a map ( [symbol] [symbol] (-go), [symbol] [symbol] )” includes two types of instructions, the control unit 70 generates a control signal corresponding to the two types of instructions and sends the control signal to the navigator.

Meanwhile, this patent application has been derived from researches carried out as part of “IT Convergence Technology Development Project” [Project Number: A1210-1101-0003, Project Name: Interactive Voice Recognition Development for Vehicle based on Server] supported by National IT Industry Promotion Agency of Korea.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A voice recognition method for a single sentence comprising multiple instructions, the method comprising steps of:
(i) detecting a connection ending by analyzing morphemes of a single sentence on which voice recognition has been performed;
(ii) separating the single sentence into a plurality of passages based on the connection ending;
(iii) detecting a multi-connection ending by analyzing the connection ending and extracting instructions by specifically analyzing passages comprising the multi-connection ending; and
(iv) outputting a multi-instruction included in the single sentence by combining the instructions extracted at step (iii).

2. The voice recognition method of claim 1, wherein the multi-connection ending is any one of a multi-operation connection ending, a consecutive connection ending, and a time connection ending.

3. The voice recognition method of claim 2, wherein the multi-operation connection ending is any one selected from a group consisting of ‘-go (and, - [symbol] )’, ‘-wa (and, - [symbol] )’, ‘-gwa (and, - [symbol] )’, and ‘-lang (and, - [symbol] )’.

4. The voice recognition method of claim 2, wherein the consecutive connection ending comprises ‘-umyeonseo (and, - [symbol] )’.

5. The voice recognition method of claim 2, wherein the time connection ending is any one selected from a group consisting of ‘-go (and, - [symbol] )’, ‘-umyeo (and, - [symbol] )’, ‘-umyeonseo (and, - [symbol] )’, ‘-ja (as soon as, - [symbol] )’, and ‘-jamaja (as soon as, - [symbol] )’.

6. The voice recognition method of claim 1, wherein the step (iv) is a process of generating a control signal corresponding to the multi-instruction and sending the control signal to a corresponding device.

7. The voice recognition method of claim 1, wherein the step (i) comprises processes of:
recognizing a user's voice for the single sentence;
analyzing the morphemes of the single sentence through a morpheme analyzer; and
detecting the connection ending from the morphemes through a multi-connection ending database (DB).

8. The voice recognition method of claim 1, wherein the step (iii) comprises:
an analysis target determination process of detecting the multi-connection ending by analyzing the connection ending and classifying the multi-connection ending into a subject of analysis and a subject of non-analysis depending on whether the multi-connection ending is present or not, and
extracting the instructions by matching passages, corresponding to the subject of analysis, with a language information DB 60 in which a language information dictionary has been previously constructed.

9. The voice recognition method of claim 8, wherein the language information DB comprises a meaning hierarchy word DB and a sentence pattern DB.

10. The voice recognition method of claim 8, wherein the instruction extraction process comprises processes of:
extracting meaning values by matching the passages, corresponding to the subject of analysis, with the language information DB;
analyzing a type of sentence of the passages from which the meaning values have been extracted;
classifying the type of analyzed sentence into a subject of output processing and a subject of error processing through a previously constructed sentence pattern DB; and
extracting an instruction by assigning a final operation value to a passage selected as the subject of output processing.
